(19) United States
(12) Patent Application Publication
(10) Pub. No.: US 2009/0254212 A1
(43) Pub. Date: Oct. 8, 2009

(54) BULK FLATS INDUCTION METHOD AND SYSTEM

(75) Inventors: Mark T. NEEBE, Catonsville, MD (US); Randall K. Neilson, Crownsville, MD (US); Matthew G. Good, Marriotsville, MD (US); Mark D. Bittenbender, Columbia, MD (US); Thomas A. Hillerich, Columbia, MD (US)

Correspondence Address: ROTHWELL, FIGG, ERNST & MANBECK, P.C., 1425 K STREET, N.W., SUITE 800, WASHINGTON, DC, 20005, US

(73) Assignee: Northrop Grumman Systems Corporation, Los Angeles, CA (US)

(21) Appl. No.: 12/266,000

(22) Filed: Nov. 6, 2008

Related U.S. Application Data
(60) Provisional application No. 60/986,417, filed on Nov. 8, 2007.

(51) Int. Cl. B07C 5/00; G06F 7/00

(52) U.S. Cl. 700/224; 209/584

(57) ABSTRACT

A method and system for transferring flats mail from palletized bundles into a flats sorting system. The bundles are loaded into a system in which they are scanned for delivery zone information. The bundles are transported to a tray loading station based on delivery zone. The flats mail is unbundled and placed into system trays at the tray loading stations. The system trays are then transported to a flats sorting system.

### CROSS-REFERENCE TO RELATED APPLICATION

This application claims priority from U.S. provisional patent application No. 60/986,417, filed on Nov. 8, 2007, the disclosure of which is incorporated herein by reference.

### BACKGROUND OF THE INVENTION

1. Field of the Invention

The present invention relates generally to mail sorting systems and, more particularly, to a method and system for processing bulk flats prior to sorting.

2. Discussion of Related Art

Mail sorting techniques have changed dramatically in recent years. The sorting of mail flats has become largely automated with systems such as the Northrop Grumman Automated Flats Sorting Machine (AFSM) increasing efficiency while reducing labor cost and requiring less floor space.

Bulk flats generally arrive at the mail sorting facility in bundles on a pallet. In the past, these pallets were manually broken down, and the bundles were removed one at a time. The straps or wrap binding each bundle would then be manually removed so that the flats mail in the bundle could be manually placed into the feeder of a mail sorting system or manually placed into a tray which was then placed into the mail sorting system. This process was time consuming, required a large amount of floor space and was costly due to the need for many laborers.

Various systems have been proposed to reduce the time, space and cost of handling bulk flats. U.S. Pat. No. 7,287,952 is an example of a method and system for unloading bundles from a pallet. In some proposed systems, a pallet is lifted to a conveyer mechanism which then takes the bundles from the pallet. The bundles go to a distribution conveyer which then delivers bundles to a particular mail sorting system induction area based on bar code information. A disadvantage of the proposed systems is that the mail must still be manually unbundled and manually loaded into the feeder of a flats sorting system.

### SUMMARY OF THE INVENTION

The present invention overcomes the disadvantages of the prior art by automatically unbundling the incoming mail and placing the unbundled mail into trays compatible with an automated flats sorting system, such as the Northrop Grumman Flats Sequencing System (FSS), the Northrop Grumman Automated Flats Sorting Machine (AFSM) or any other system capable of receiving automation compatible trays. The present invention is also capable of placing the flats mail into trays corresponding to delivery zone to greatly increase efficiency and reduce processing time.

In accordance with a first aspect of the present invention, a method of unloading flats mail from bundles on a pallet into a flats sorting system includes unloading a bundle of mail from a pallet into a bulk flats induction system, scanning address information on a piece of mail in the bundle, determining a delivery zone for the mail in the bundle based on the address information obtained by scanning, assigning the bundle of mail to a tray loading station based on the determined delivery zone, unbundling the mail, loading the unbundled mail into at least one system tray at the assigned tray loading station and transporting said at least one system tray to the flats sorting system.

In an embodiment, the transporting step includes loading the system trays into a dolly. The transporting step may also include transporting the system trays to the dolly by conveyer. In another embodiment, the system trays are loaded into a dolly at a dolly docking station. In an embodiment, the loading step includes forming a stack of mail of predetermined depth and loading the mail stack into a system tray.

In accordance with a second aspect of the present invention, a bulk flats induction system for transferring palletized bundles of mail into a flats sorting system includes a bundle scanning apparatus, a plurality of tray loading stations, one or more tray transports and a controller. The scanning apparatus includes a bundle input and a scanner configured to read address information on a mail item in the bundle. The plurality of tray loading stations are positioned to receive bundles from the scanning apparatus. The one or more tray transports are operable to receive trays from the tray loading station and move the trays to the flats sorting system. The controller is in communication with the bulk flats processing system for determining a delivery zone for each bundle and assigning a tray loading station based on the determined delivery zone.

In an embodiment, the tray transport apparatus includes a plurality of dolly docking stations positioned to receive trays from said plurality of tray loading stations. In another embodiment, the system may further include a tray stacker configured to receive trays from the plurality of tray loading stations and stack the trays on a dolly. In an embodiment, the tray loading station includes an unbundling apparatus to unbundle the bundles received at the station. The unbundling apparatus may include at least one of a circular saw, a heat knife, a sweeping double blade and a blade/shear. In an embodiment, the tray loading station includes a mail stacker.

In accordance with a third aspect of the present invention, a bulk flats induction system for transferring mail from palletized bundles into a flats sorting system includes means for accepting one or more bundles of mail and scanning address information on a piece of mail in each bundle, means for unbundling the mail, means for loading the unbundled mail into at least one system tray and means for transporting the system trays to the flats sorting system.

In an embodiment, the system includes means for controlling the system. The means for controlling may determine a delivery zone for bundles from the address information scanned and assign each bundle a sort plan. In an embodiment, the means for transporting includes one or more dollies. In another embodiment, the means for transporting also includes a means for stacking the trays prior to transporting the trays on one or more dollies.

In an embodiment, a full Auto-Ready Pallet of strapped bundles is loaded into the Unloader or pallet docking area, and the operator starts the unloading sequence. Spring loaded pallet retainers hold the pallet in the Unloader as the Unloader tilts upwards. The operator removes bundles from the Unloader and places them on the bundle conveyor. The bundles are oriented so the bundles will be placed in the ACTs or system trays in a preferred way. A conveyor moves bundles through the scanning and dimensioning station or bundle scanning apparatus where the top address label of the bundle is read and the dimensions are measured in length and width. The label information identifies which sort plan the bundle belongs to and this determines to which Automatic Stacker/Loader station or tray loading station the bundle is diverted. The bundles are then conveyed onto the Bundle Distribution System. The Bundle Distribution System can use a modular belting design conveyor, such as a style with embedded directional rollers which diverts bundles to the designated Automatic Stacker/Loader. A pneumatically raised roller bed under the conveyor belt can be used to initiate the divert. The motion of the conveyor belt rollers cross the rollers in the roller bed to cause a side motion to be imparted on the bundles, and they pass to the Automatic Stacker/Loader induct conveyor. The number of diverts necessary to handle six zones will vary depending on the system design but could be up to six. Any number of diverts, up to six, one for each individual sort plan, can be active in the bulk flats induction system at one time. Any bundles that do not fit into the six sort plans being processed are passed to the end of the conveyer and deposited into an overflow receptacle. These bundles are processed during a subsequent run.

The bundles of mail at the Automatic Stacker/Loader are unbundled and loaded into empty ACTs. Empty ACTs are supplied to the system by dollies at the dolly dock. A stack of three empty ACTs exit from the Dolly Dock and pass to the ACT Destacker. The ACT Destacker converts the stack of three ACTs into individual empty ACTs. The ACT passes to the transport conveyor and moves to the Automatic Stacker/Loader. At each Automatic Stacker/Loader station the ACTs are diverted into the induct line. When a full ACT moves from the Automatic Stacker/Loader, a barcode reader scans the ACT barcode. The ACT is held in a conveyor spur section until three full ACTs are present. Once three full ACTs are present, the group of ACTs proceeds onto the main ACT line via a t-bone transfer and are passed to the ACT Stacker. The ACT stacker stacks the three full ACTs and passes them to the Dolly Dock or dolly docking station associated with the mail sort plan.

The Dolly Dock loads or unloads ACTs from a dolly. An embodiment of a dolly may be capable of handling stacks of 12 ACTs in a 2×2×3 matrix. When a dolly full of empty ACTs is brought into the system, the Dolly Dock pneumatically engages the Dolly to hold the Dolly in the proper position. Once locked in place, a dolly pop-up unit (DPU) with roller transfer tables disengages the dolly stabilizing bars. Full ACTs pass from the ACT Stacker and are conveyed to the appropriate Dolly Dock. Once the stack is present at a DPU, a stack of empty ACTs is off-loaded and the stack of full ACTs is loaded onto the DPU. The stack of empty ACTs proceeds to an ACT Destacker. This action repeats until all four stacks of empty ACTs have been replaced with full ACTs. The DPU disengages the Dolly, an alert is generated and an operator removes the Dolly of full ACTs and replaces it with a Dolly of empty ACTs. The alert may be a stack light positioned at the Dolly Dock. This operation continues at all six Dolly Dock stations.

The above and other features and advantages of the present invention, as well as the structure and operation of preferred embodiments of the present invention, are described below with reference to the accompanying drawings.

### BRIEF DESCRIPTION OF THE DRAWINGS

The accompanying drawings, which are incorporated herein and form part of the specification, help illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a perspective view showing a bulk flats induction system according to an embodiment of the present invention

FIG. 2 is a flow-chart showing a method of transferring palletized bulk flats bundles into a flats sorting system according to an embodiment of the present invention.

FIG. 3 is a perspective view showing an embodiment of a tray loading station for a bulk flats induction system according to the present invention.

FIG. 4(a) is a perspective view showing an embodiment of an unbundling apparatus for tray loading station in a bulk flats induction system according to the present invention.

FIG. 4(b) is a perspective view showing details of an unbundling apparatus according to the present invention.

FIG. 5 is a perspective view showing details of an indexer for the unbundling apparatus in a bulk flats induction system according to an embodiment of the present invention.

FIG. 6 is a plan view showing details of a gripper/cutter for an unbundling apparatus in a bulk flats induction system according to the present invention.

FIG. 7 is a perspective view showing an embodiment of a stacker/loader for a tray loading station in a bulk flats induction system according to the present invention.

FIGS. 8(a) and 8(b) are perspective views showing a system tray being loaded at a tray loading station for a bulk flats induction system according to an embodiment of the present invention.

FIG. 9(i) through (ix) is a side view of the tray loading station in operation according to an embodiment of the present invention.

FIGS. 10(a) and 10(b) are perspective and top views of a dolly docking station for a bulk flats induction system according to an embodiment of the present invention.

FIGS. 11 (a), 11 (b) and 11 (c) are flow charts showing various implementations of the bulk flats induction method and system of the present invention.

### DETAILED DESCRIPTION OF PREFERRED EMBODIMENT

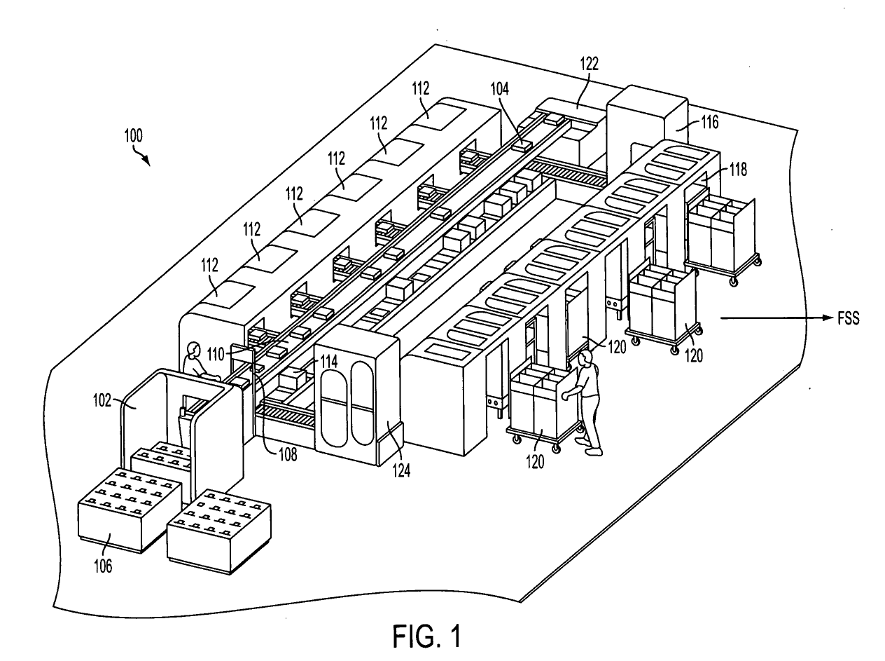

FIG. 1 shows a bulk flats induction system 100 for transferring bulk flats mail from bundles on a pallet to a flats sorting system according to an embodiment of the present invention. The bulk flats induction system 100 includes a pallet docking area 102 for staging flats mail bundles 104 on pallets 106, a bundle scanning apparatus 108 and a conveyor 110 for conveying the flats mail bundles from the bundle scanning apparatus to a plurality of tray loading stations 112 where the flats mail is unbundled, indexed and loaded into automation compatible trays (ACTs) 114, such as, e.g., the tray disclosed in U.S. patent application Ser. No. 10/927,542, which is incorporated herein by reference. The system 100 also includes a tray stacker 116 that receives loaded ACTs from the tray loading stations 112 and stacks the trays for delivery to a plurality of dolly docking stations 118 where the stacks of loaded trays are transferred to dollies 120 for transport to a flats sorting system. Empty trays from the flats sorting system are returned on dollies 120 which are unloaded at dolly docking stations 118 and transferred to tray loading stations 112 via a tray unstacker 124. Also shown is an overflow receptacle 122 at one end of the conveyor 110 for receiving flats mail bundles that are not assigned to a tray loading station 112 by the system.

In operation, the bulk flats mail is unloaded from a pallet by an operator at the pallet docking area 102. At this point, the bulk flats mail is in bundles which are placed on the conveyer 110 by the operator. The bundles of mail are scanned for address information by the bundle scanning apparatus 108. A controller determines a delivery zone for the mail in the bundle based on the scanned address information and assigns the bundle a tray loading station 112 based on the determined delivery zone. Any bundle of mail that does not have a delivery zone matching one of the tray loading stations is deposited in the overflow receptacle 122. The other bundles of mail are conveyed to their assigned tray loading stations 112. At the tray loading stations 112, the bundles of mail are unbundled and loaded into system trays 114. The system trays 114 are then conveyed to the tray stacker 116 which stacks the trays three-deep. The stacks of trays are then conveyed to the dolly docking station 118. At the dolly docking station 118, the stacks of system trays are loaded onto a dolly 120 for transport to the flats sorting system.

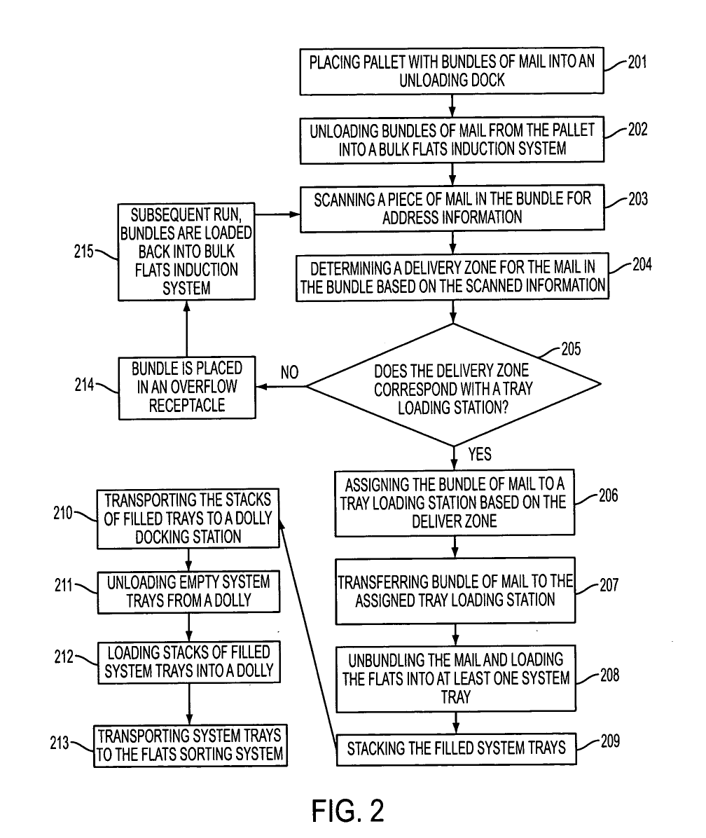

FIG. 2 is a flow chart showing a method for unloading flats mail from bundles on a pallet into a flats sorting system in accordance with the present invention. In step 201, a pallet 106 is placed in the docking area 102. The pallet 106 may be placed manually, with a fork lift or any other means of transport. In an embodiment, the docking area 102 includes a spring loaded platform that maintains the pallet at a pre-determined height facilitating ergonomic unloading of bundles to prevent work injury. The bundles of mail 104 are then manually unloaded from the pallet 106 by the operator and placed on the conveyer 110 one at a time at step 202. In step 203, the bundle 104 is conveyed past the scanning apparatus 108 and a piece of mail is scanned for address information. The top piece of mail in the bundle is the piece generally scanned for this information. The bindings on the bundle of mail must be placed such that the address information is not obstructed. If there is an error in reading the information a picture of the mail may be sent to the operator or an operator may come and properly orient the bundle. In step 204, the system determines a delivery zone for the mail in the bundle based on the information scanned.

The bulk flats induction system 100 includes a plurality of tray loading stations 112 that are each assigned a delivery zone. In step 205, the system determines if there is a tray loading station 112 corresponding to the delivery zone determined in step 204. The delivery zones can be assigned prior to beginning the run for a pallet 106 or in real time as the bundles are processed. For example, in an embodiment there may be six tray loading stations 112. These six loading stations 112 each handle a different delivery zone. So, six delivery zones may be handled for a particular pallet in this embodiment. Tray loading stations 112 are assigned a delivery zone as bundles 104 are scanned. If there are seven delivery zones on a pallet then the bundles corresponding to the seventh delivery zone will not be processed on that run. Bundles that are not processed are placed in an overflow receptacle 122 at step 214. The bundles in the overflow receptacle can be processed through the bulk flats induction system on a subsequent run, step 215. If a tray loading station 112 does have the same delivery zone as the bundle 104 then the bundle 104 is assigned to the corresponding tray loading station 112 at step 206. In step 207, the bundle of mail 104 is transferred to the assigned tray loading station 112. In an embodiment, the bundle 104 may be transferred to the tray loading station 112 by a series of conveyers 110. At the tray loading station, the bundle of mail 104 is unbundled, indexed and loaded into at least one system tray 114, step 208. The bundle 104 may be unbundled by cutting the strap that binds the bundle 104, e.g by use of an instrument such as a circular saw, a heat knife, a sweeping double blade, shear/blade or other instruments capable of cutting the binds. The unbundled mail may require more than one system tray 114 because the size of the bundle may exceed the maximum capacity of the system tray 114. For example, a system tray 114 may have a maximum capacity of 11 inches. If a bundle of mail exceeds 11 inches, the maximum capacity of the system tray 114, then the unbundled mail may be separated into stacks within the capacity of the system tray 114. The system trays 114 are then transported to the tray stacker 116 at step 209. The tray stacker 116 stacks the filled system trays 114 three-deep. The stack of system trays is then transported to the dolly docking station 118 at step 210. A dolly 120 full of empty system trays is placed in the dolly docking station 118. In step 211, the empty system trays are unloaded from the dolly 120. In an embodiment, the empty system trays are unloaded in stacks which are then unstacked by a tray unstacker 124. The stacks of filled system trays are loaded onto the dolly 120 at step 212. The dolly 120 with filled system trays is then transported to the flats sorting system at step 213.

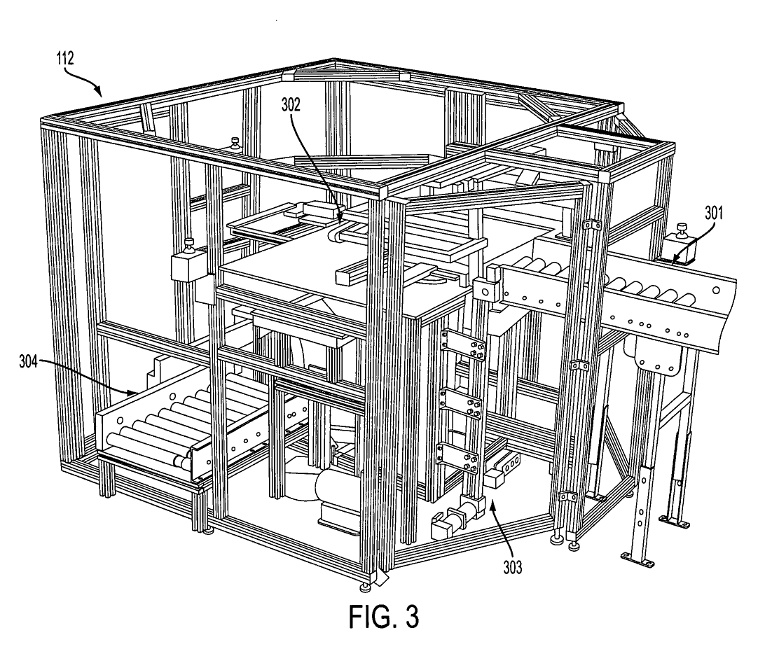

FIG. 3 shows a tray loading station 112 for use in a bulk flats induction system according to an embodiment of the present invention. The tray loading station 112 includes a bundle input conveyor 301, an unbundling apparatus 302, a mail stacker/loader 303 and an output conveyor 304. A bundle of mail 104 is transferred to the station by a bundle input conveyer 301. A problem with the conveyer can be long bundles catching on the wall edge parallel to bundle travel causing the bundle to skew and the machine to jam. In the present invention, this problem is solved by skewing the input conveyer 301 to ensure the bundle is square when it is input. The bundle of mail 104 is then placed in the unbundling apparatus 302. In the unbundling apparatus 302, the straps that hold the bundle together are removed. The unbundled mail is then passed to the mail stacker/loader 303. The mail stacker/loader 303 will separate a stack of mail from the unbundled mail and place the stack of mail into a system tray 114. The system trays 114 are then transferred out of the tray loading station 112 by an output conveyer 304.

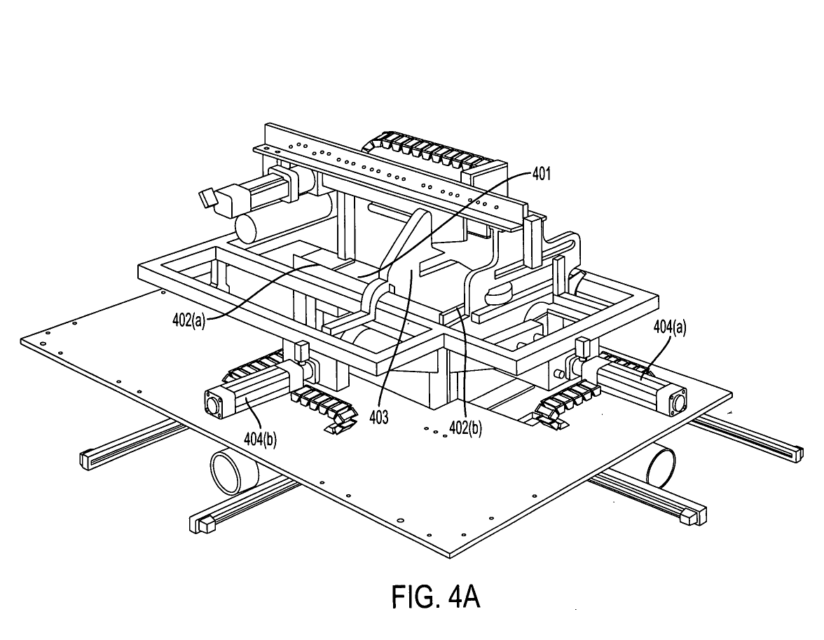

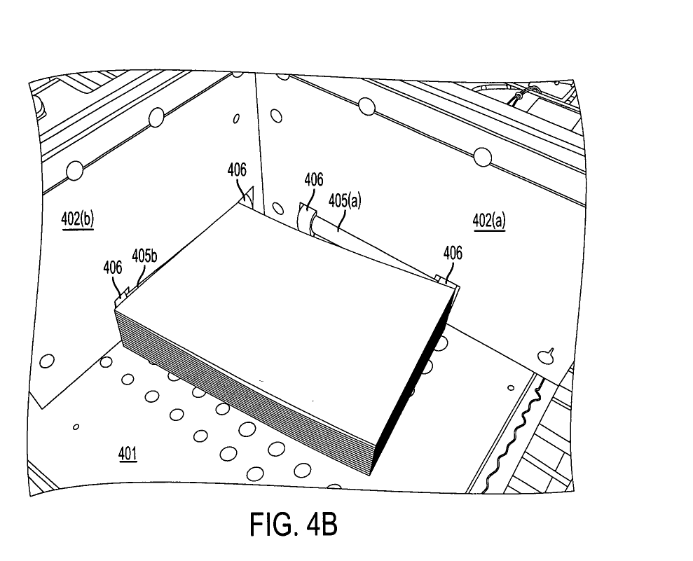

FIGS. 4(a) and 4(b) shows the unbundling apparatus 302 of a tray loading station 112. The unbundling apparatus 302 includes a slip sheet 401, two fixed walls 402(a) and 402(b), an indexer 403, a gripper/cutter 404, rectangular cut outs in the fixed walls 405(a) and 405(b) and deformers on the ends of the cut outs 406. The bundle of mail 104 is conveyed into the unbundling apparatus 302 where it is placed on a slip sheet 401. The slip sheet 401 is the floor of the unbundling apparatus 302. There are two fixed walls 402(a) and 402(b) perpendicular to the slip sheet 401. An indexer 403 capable of moving about the unbundling apparatus takes the bundle from the conveyer and properly orients it. The straps of the bundle are cut and removed by the strap gripper/cutter 404 which accesses the bundle through rectangular cut-outs in the fixed walls 405(a) and 405(b). The gripper/cutter 404 can be moved towards or away from the bundle to engage the straps. On the ends of each cut-out are deformers 406 to create space for the gripper/cutter 404 to engage the strap. After the flats mail has been unbundled, the slip sheet floor 401 is removed and the mail falls into the stacker/loader 303. There is a photo eye present in the slip sheet 401 to detect when all of the unbundled mail has passed to the stacker/loader 303.

One issue can be the cut-outs 405(a) and 405(b) in the fixed wall catch the bundle during orientation. A solution to this problem can be to actuate the upper part of the wall such that as the bundle is being indexed into position the hole is covered. Once the bundle is positioned the wall will shift, providing the required hole for the gripper/cutter 404. Another issue with the cut-outs 405(a) and 405(b) occurs if the bottom of the cut-out hole is above the top of the slip sheet 401. This causes the strap to be pulled around the wall during removal by the gripper/cutter. A solution to this problem can be to lower the bottom of the cut out 405(a) and 405(b) hole. An issue with the deformers 406 can be deforming tightly strapped bundles to create space for the gripper/cutter 404 to engage the strap. A solution to this problem can be to provide a bundle deformer actuator with a proper bore separate from the strap remover head in/out actuator, effectively providing more deformer force. Finally, the distance from the face of the deformer to the face of the grippers can be minimized.

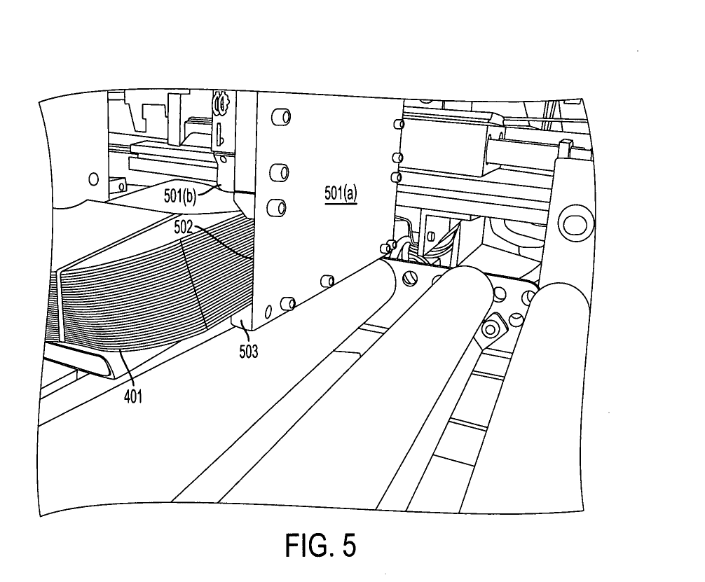

FIG. 5 shows an indexer 403 of the unbundling apparatus in the tray loading station 112. The indexer 403 includes two walls 501(a) and 501(b), in an L-shape, which can engage the bundle. These walls 501(a) and 501(b) have receiver pockets 502 that include wedge lead-ins 503 on the bottom of the wall. Spacing between the indexer walls 501(a) and 501(b) and the bundle is critical. If the indexer 403 is too tight or too loose, the gripper/cutter 404 cannot properly cut the straps of the bundle. One way of dealing with these problems is the actuators of the indexer can be servo driven to be adjustable based on bundle size. Also, sensor feedback can be used to determine when the indexer 403 has correctly oriented the bundle. The sensor feedback can include pressure sensing spring loaded actuator, spring loaded indexer walls and an S/W timer.

Another issue is the bundles can stick to the slip sheet 401 and ride up into the receiver pocket 502, preventing proper deformation. One way of dealing with this problem is to provide a receiver pocket 402 with pneumatic or spring loaded surfaces that push back on the mail. Also, the end of the input conveyer 301 can be lowered so that the clearance between the slip sheet 401 and the bottom of the indexer wall 501(a) and 501(b) can be minimized and the wedge lead-in 503 can be reduced. Finally, the receiver pocket 502 can be raised, thus reducing the wedge lead-in 503. Another issue can be mail sticking to the indexer wall 501(a) and 501(b). This causes the mail to improperly fall into the stacker/loader 303 and can block the slip sheet photo eye. When the slip sheet photo eye is blocked the stacker/loader 303 will continue to descend and the slip sheet 401 will not move back into place to accept more bundles. A solution to this problem can be to eliminate the catch points on the indexer walls 501(a) and 501(b). Another solution can be to measure the height of the bundle prior to adding to the stack in the stacker/loader 303, so that if the slip sheet photo eye has not released within the proper stack distance an error can be displayed.

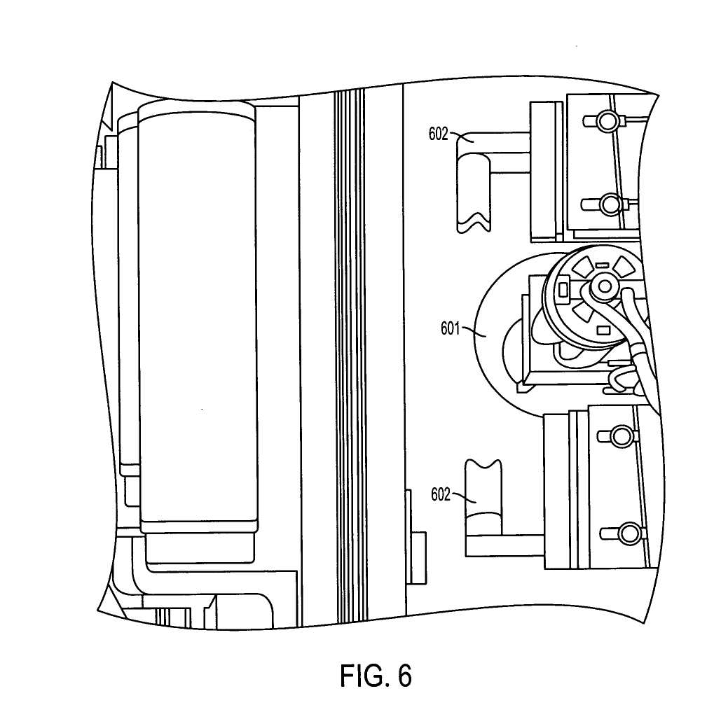

FIG. 6 shows the gripper/cutter 404 of the unbundling apparatus in tray loading station 112. The gripper/cutter 404 includes a cutter 601 and grippers 602. The cutter 601 cuts the straps binding the bundles as the grippers 602 hold the strap. In an embodiment, the cutter 601 can be a circular saw. Other cutting instruments may be used including a heat knife, a sweeping double blade and a blade/shear. An issue can be the grippers 602 dropping the straps. A solution to this issue can be to improve the gripper 602 hold on the straps with gripper profiles and coating. The gripper 602 will be designed so that the strap breaks before it is pulled from the gripper 602.

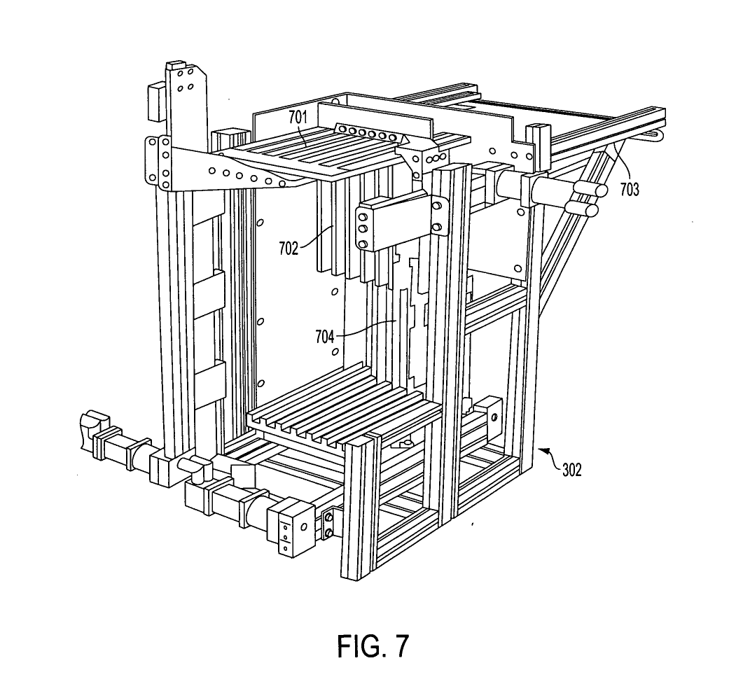

FIG. 7 shows the stacker/loader 303 of the tray loading station 112. The stacker loader 303 includes a stacker 701, a configurable wall 702, a separator 703 and a tray loader 704. When the slip sheet 401 is removed, the unbundled mail is placed on the stacker 701. The stacker 701 is capable of moving vertically. As the stacker 701 descends with the unbundled mail, a configurable wall 702 keeps the mail in place. The unbundled mail may be separated into smaller stacks by the separator 703. The stack of mail created by the separator 703 will be a predetermined size capable of filling a system tray 114. The stack is placed into a system tray 114 by the tray loader 704.

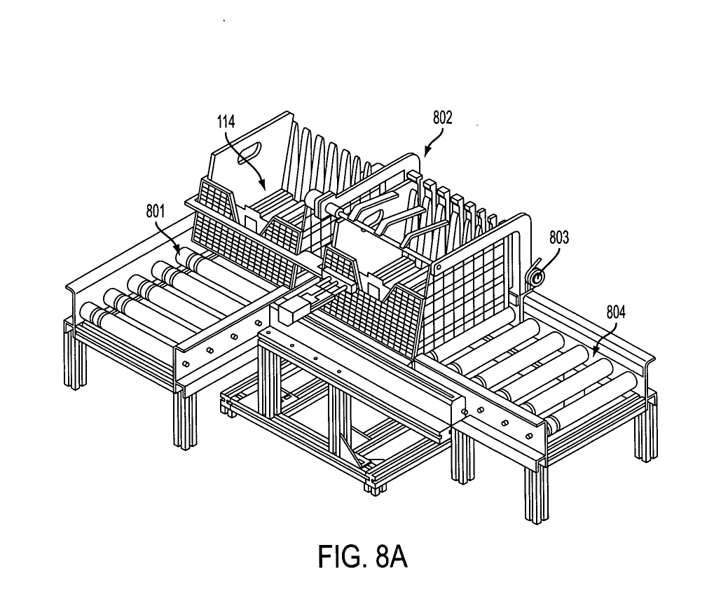

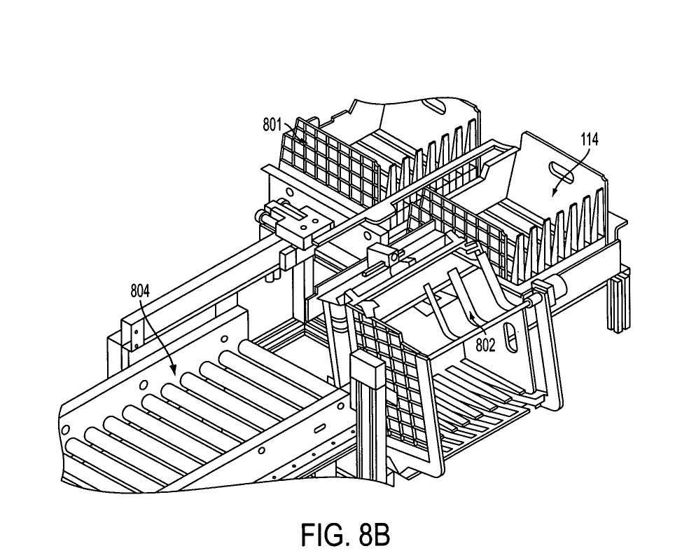

FIGS. 8 (a) and 8 (b) show the system tray 114 being loaded at the tray loading station 112. The system trays 114 are input to the tray loading station 112 by a conveyer 801. The system tray is then covered by the mail retainer 802. The system tray is rotated into a loading position by the tray rotator 803. FIG. 8 (b) shows a tray that has been rotated into loading position. After the tray has been loaded with flats mail, the tray is transferred out of the tray loading station by a conveyer 804.

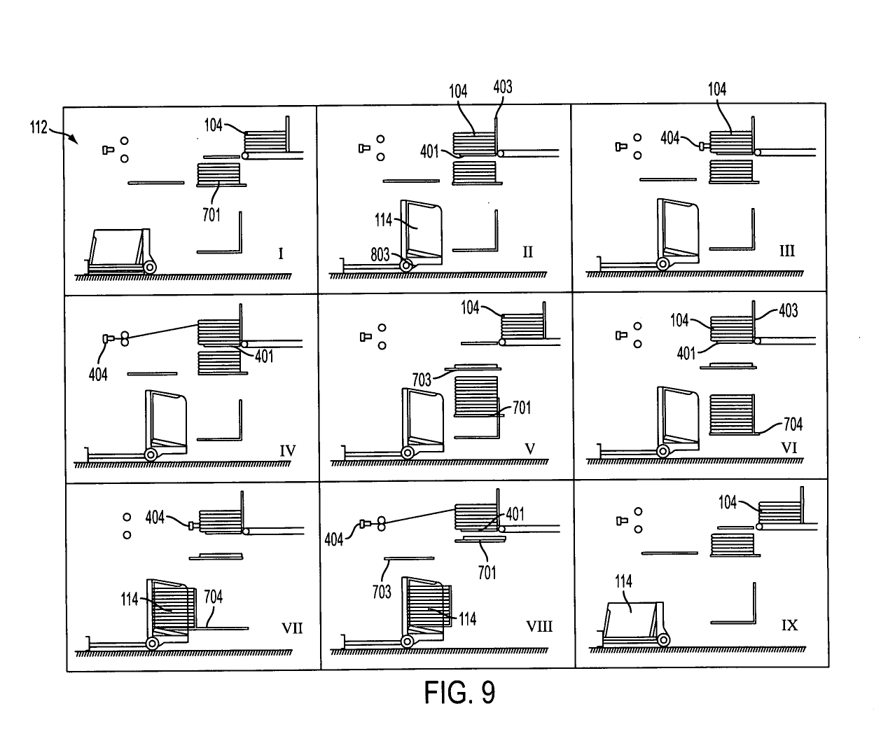

FIG. 9 shows the tray loading station 112 in operation in an embodiment of the present invention. In frame (i), a bundle 104 enters the tray loading station 112 and unbundled mail is on the stacker 701. In frame (ii), the tray rotator 803 rotates a system tray 114. The indexer 403 moves the bundle of mail 104 onto the slip sheet 401. In frame (iii), the gripper/cutter 404 engages the straps of the bundle 104. In frame (iv), the gripper/cutter 404 has cut the straps. Between frames (iv) and (v), the slip sheet 401 is removed and the unbundled mail is passed to the stacker 701. In frame (v), the stacker 701 descends and the separator 703 separates some unbundled mail from the stack. The remaining stack of unbundled mail is within the capacity of the system trays. A new bundle of mail 104 enters into the tray loading station 112. In frame (vi), the unbundled mail is placed in the tray loader 704. The indexer 403 moves the bundle of mail 104 onto the slip sheet 401. In frame (vii), the tray loader 704 loads the unbundled mail into a system tray 114. The gripper/cutter 404 engages the straps of the bundle of mail 104. In frame (viii), the stacker 701 takes the remaining unbundled mail from the separator 703. The gripper/cutter has cut the straps. Between frames (viii) and (ix), the slip sheet 401 is removed and the unbundled mail is passed to the stacker 701 and the filled system tray 114 is rotated back into place and transported from the tray loading station 112. In frame (ix), a new bundle of mail 104 and an empty system tray 114 arrive at the tray loading station 112.

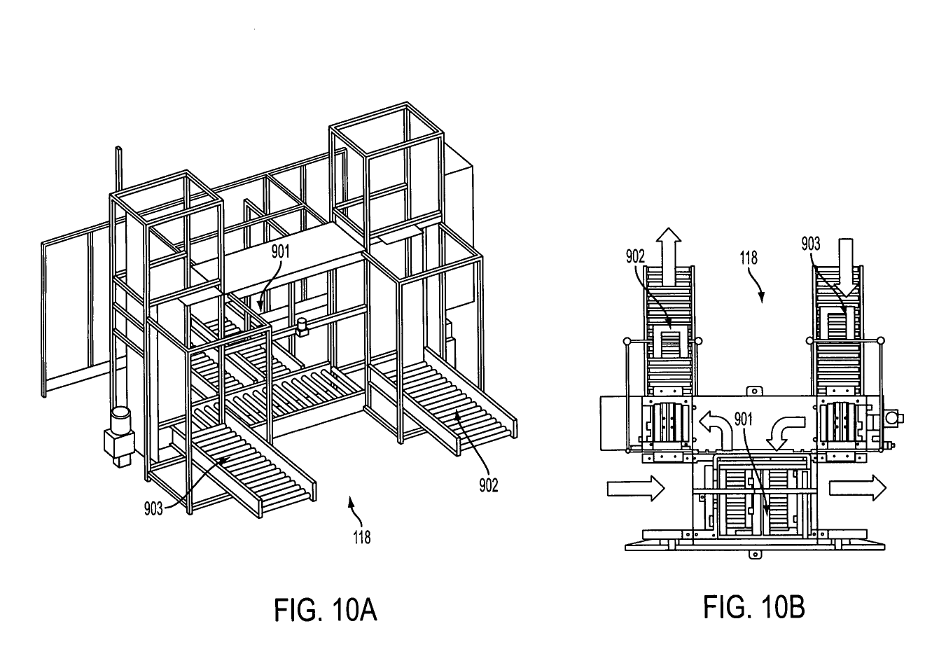

FIGS. 10 (a) and 10 (b) show a dolly docking station 118. A dolly 120 full of empty system trays is placed in the dolly dock 901. The dolly dock 901 engages with the dolly 120 so as to lock the dolly 120 in the proper position. The empty system trays are unloaded from the dolly 120 and transported into the bulk flats induction system by a conveyer 902. Full system trays are transported to the dolly dock 118 by a conveyer 903. The full system trays are loaded into the empty dolly 120. When the dolly 120 is full the dolly dock 901 disengages the dolly 120 and signals an operator to transport the full dolly 120 to the flats sorting system.

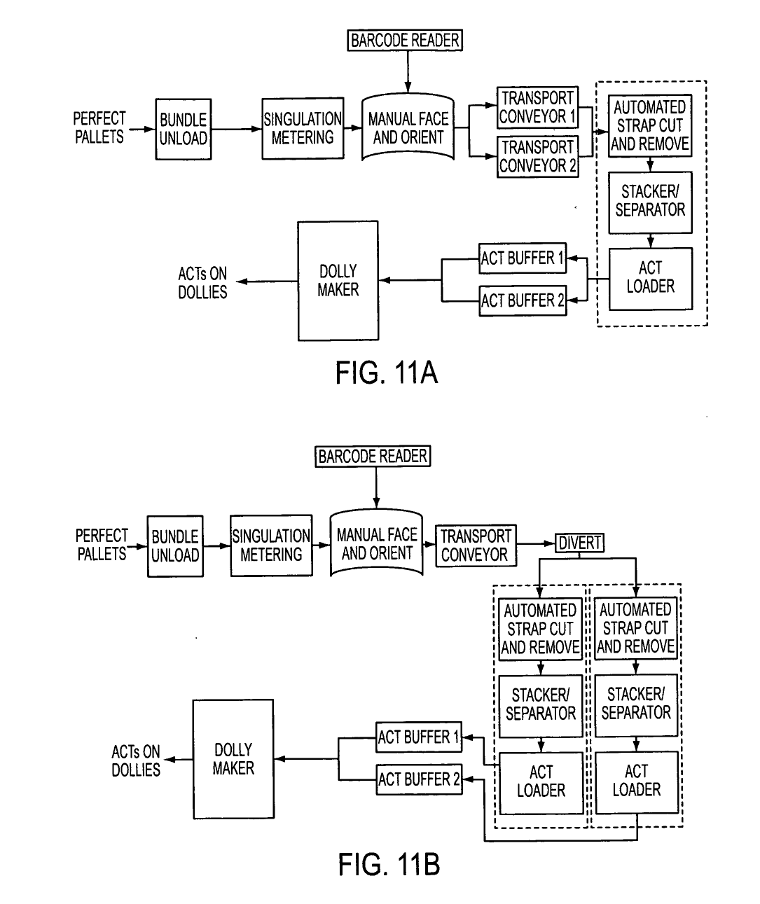

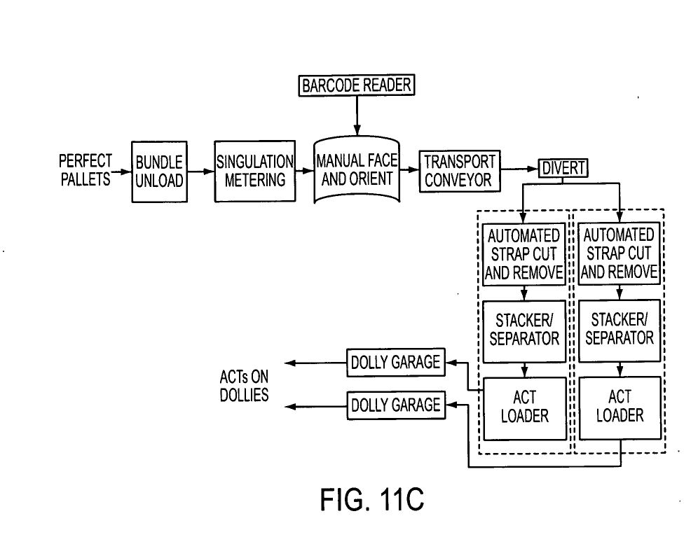

FIGS. 11 (a), 11 (b) and 11 (c) show various implementations of a bulk flats induction method and system of the present invention. In all three figures, bundles 104 are unloaded from a pallet 106 onto a conveyor one at a time. A barcode on the bundle is scanned and the bundle is transported to a tray loading station 112. In FIG. 11 (a), the ACTs or system trays 114 filled at the tray loading station 112 are buffered prior to being transported to the dolly docking station 118. In FIG. 11 (b), the bulk flats induction system has multiple tray loading stations 112. The filled ACTs or system trays 114 are buffered prior to being transported to the dolly docking station 118. In FIG. 11 (c), the filled ACTs or system trays 114 are not buffered prior to being transported to a dolly docking station.

While specific embodiments have been shown and described, it will be appreciated by those of skill in the art that various modifications can be made without departing from the spirit and scope of the following claims. For example, the system can be combined with an automatic pallet loader/unloader, an automatic dolly handling system or an automatic dolly stacker/unstacker, such as the dolly stacker described in the commonly owned, co-pending U.S. patent application Ser. No. 11/709,830, the disclosure of which is incorporated herein by reference. In the case of an automatic dolly handling system, dollies full of empty ACTs can be placed on a conveyer extending the length of the dolly docking station and automatically moved into a transfer position in front of any one of the dolly docking stations. Dollies with empty trays are inserted into any open dolly docking station and unloaded. Once a dolly has been filled with full ACTs, the dolly can be ejected back into the dolly handling system and sent to the exit of the system.

We claim the following:

1. A method for transferring flats mail from palletized bundles into a flats sorting system, comprising:
unloading a bundle of mail from a pallet into a bulk flats induction system;
scanning address information on a piece of mail in the bundle of mail;
determining a delivery zone for the mail in the bundle based on the address information obtained by scanning;
assigning the bundle of mail to a tray loading station based on delivery zone;
unbundling the mail;
loading the unbundled mail into at least one system tray at the assigned tray loading station; and
transporting said at least one system tray to the flats sorting system.

2. The method of claim 1, wherein transporting said at least one system tray to the flats sorting system includes loading said at least one system tray into a dolly.

3. The method of claim 2, wherein transporting said at least one system tray further includes stacking a plurality of system trays and loading said stacked trays into a dolly.

4. The method of claim 2, wherein transporting said at least one system tray to the flats sorting system includes loading said at least one system tray into a dolly at a dolly docking station

5. The method of claim 4, wherein said at least one system tray is transported by conveyer to the dolly docking station.

6. The method of claim 1, further comprising unloading empty system trays from a dolly at the dolly docking station.

7. The method of claim 6, further comprising unstacking empty system trays.

8. The method of claim 1, wherein loading the unbundled mail into at least one system tray includes forming a mail stack of predetermined depth and loading the mail stack into a system tray.

9. A bulk flats induction system for transferring flats mail from palletized bundles into a flats sorting system, comprising:
a bundle scanning apparatus with a bundle input and a scanner configured to read address information on a mail item in the bundle;
a plurality of tray loading stations positioned to receive bundles from the bundle scanning apparatus;
one or more tray transports operable to receive trays from the tray loading stations and to move the trays to the flats sorting system; and
a controller in communication with the bulks flat induction system for determining a delivery zone for each bundle and assigning a tray loading station based on the determined delivery zone

10. The system of claim 9, wherein the tray transport apparatus includes a plurality of dolly docking stations positioned to receive trays from said plurality of tray loading stations.

11. The system of claim 10, further comprising a tray stacker configured to receive trays from said plurality of tray loading stations and stack the trays on a dolly.

12. The system of claim 9, wherein the dolly docking station is configured to unload empty trays from a dolly.

13. The system of claim 12, further comprising a tray unstacker positioned to receive stacks of empty trays and to pass unstacked empty trays to the plurality of tray loading stations.

14. The system of claim 9, wherein said plurality of tray loading stations include an unbundling apparatus to unbundle the bundles received at the station.

15. The system of claim 14, wherein said unbundling apparatus includes at least one of a circular saw, a heat knife, a sweeping double blade and a blade/shear.

16. The system of claim 9, wherein the plurality of tray loading stations include a mail stacker.

17. A bulk flats induction system for transferring flats mail from palletized bundles into a flats sorting system, comprising:
means for accepting one or more bundles of mail from a pallet and scanning address information on a piece of mail in each bundle;
means for unbundling the mail;
means for loading the unbundled mail into at least one system tray; and
means for transporting said at least one system tray to the flats sorting system.

18. The system of claim 17, further comprising means for controlling the system.

19. The system of claim 18, wherein the control means determines a delivery zone for a bundle from the address information scanned and assigns said bundle a sort plan.

20. The system of claim 17, wherein means for transporting includes one or more dollies.

21. The system of claim 20, further comprising a means for stacking said trays prior to transporting the system trays on one or more dollies.

22. The system of claim 17, further comprising means for unloading empty trays from a dolly.

23. The system of claim 22, further comprising means for unstacking a stack of empty trays.
